(19) United States
(12) Patent Application Publication
(10) Pub. No.: US 2025/0272978 A1
(43) Pub. Date: Aug. 28, 2025

(54) MACHINE LEARNING MODELS FOR VIDEO OBJECT SEGMENTATION

(71) Applicant: SAMSUNG ELECTRONICS CO., LTD., Suwon-si (KR)

(72) Inventors: Albert SAÀ-GARRIGA, Staines (GB); Mehmet YUCEL, Staines (GB); Bruno MANGANELLI, Staines (GB); Moonhwan JEONG, Suwon-si (KR); ROY MILES, Staines (GB)

(73) Assignee: SAMSUNG ELECTRONICS CO., LTD., Suwon-si (KR)

(21) Appl. No.: 19/205,505

(22) Filed: May 12, 2025

Related U.S. Application Data
(63) Continuation of application No. PCT/IB2023/061223, filed on Nov. 9, 2023.

(30) Foreign Application Priority Data
Nov. 10, 2022 (GB) 2216792.8
Nov. 6, 2023 (GB) 2317027.7

(51) Int. Cl. G06V 20/40; G06T 7/174; G06V 10/75; G06V 10/94

(52) U.S. Cl. CPC G06V 20/49; G06T 7/174; G06V 10/759; G06V 10/95; G06T 2207/10016; G06T 2207/20081

(57) ABSTRACT

The present techniques provide methods for training machine learning, ML, models to track an object through frames of a video even when the object may change shape, orientation, position, proximity and angle to a camera that captured the video, and so on.

### CROSS-REFERENCE TO RELATED APPLICATION

This application is a bypass continuation of an International Application No. PCT/IB2023/061323, filed on Nov. 9, 2023, which is based on and claims priority to United Kingdom Provisional Patent Application No. 2216792.8, filed on Nov. 10, 2022, in the United Kingdom Intellectual Property Office, and United Kingdom Complete Patent Application No. 2317027.7, filed on Nov. 6, 2023, in the United Kingdom Intellectual Property Office, the disclosures of each of which is incorporated by reference herein in its entirety.

### BACKGROUND

### 1. Field

The present disclosure relates to a computer-implemented method for training a machine learning, ML, model for semi-supervised video object segmentation. In particular, the present techniques relate to methods for training ML models to track an object through frames of a video even when the object may change shape, orientation, position, proximity and angle to a camera that captured the video, and so on.

### 2. Description of Related Art

Video Object Segmentation, VOS, is a foundational task in computer vision, where the aim is to segment and track objects in a sequence of frames. VOS is the backbone of many applications such as video editing, autonomous driving, surveillance, and augmented reality.

Semi-supervised VOS (SVOS), sometimes termed one-shot video segmentation in the literature, aims to track a given mask throughout a video based on a mask annotation for an initial frame. This is a notoriously difficult task. Currently, one needs to model the motion and appearance changes under severe occlusion and drifts, while performing well in a class-agnostic manner.

Historic SVOS approaches can be divided into three main methods: (i) online fine-tuning; (ii) object flow; and (iii) offline matching. A recent promising branch of SVOS involves memory-based matching methods. These approaches leverage memory banks to encode and memorize previous frames. They find feature correspondences between the memory and the current frame to predict subsequent object masks. By dynamically updating/populating the memory, appearance and motion changes may be modelled effectively.

Unfortunately, none of the current approaches to SVOS are appropriate to on-device deployment. In the case of memory-networks particularly, these suffer from an inherent trade-off between the memory usage and accuracy; normally, the memory requirements become increasingly larger as the network progresses through a video. Current solutions to the memory problem involve storing a reduced number of frames, storing local segmentation features (i.e., features of only a part of the image), or segmenting only on key frames. These methods are fine on server farms and extremely high-end GPUs, but are still not able to perform in real-time on edge (user) devices such as mobile phones. Moreover, such approaches do not normally leverage user data, instead requiring training on fixed offline datasets, making performance limited and prone to distribution shifts.

The applicant has therefore identified the need for a technique for object tracking on user devices which addresses one or more of the above problems.

### SUMMARY

In a first approach of the present techniques, there is provided a computer-implemented method for locally-training, on a user device, a machine learning, ML, model to perform video object segmentation and track one or more objects in a video, the method comprising: obtaining a local training dataset comprising a plurality of video clips, each video clip comprising a plurality of frames; generating a plurality of segmentation masks, each segmentation mask corresponding to a frame of a video clip of the plurality of video clips and relating to at least one object in the frame of the video clip; obtaining a pre-trained global ML model comprising a high-resolution configuration and a low-resolution configuration; and training the pre-trained global ML model to generate a locally-trained ML model using the local training dataset and the plurality of segmentation masks by: processing, using the high-resolution configuration of the global ML model, a video clip from the plurality of video clips using a segmentation mask corresponding to a frame of the video clip, and generating a first set of segmented frames based on each frame of the video clip in which the at least one object of the segmentation mask appears; generating a low-resolution version of the video clip; processing, using the low-resolution configuration of the global ML model, the low-resolution version of the video clip and the segmentation mask corresponding to the video clip, and generating a second set of segmented frames based on each frame of the low-resolution version of the video clip in which the at least one object of the segmentation mask appears; upscaling the second set of segmented frames; comparing the first set of segmented frames and the upscaled second set of segmented frames; and using a knowledge distillation loss to transfer knowledge from the high-resolution configuration to the low-resolution configuration to reduce a difference between the first set of segmented frames and the upscaled second set of segmented frames.

Thus, the present techniques aim to take a step towards real-time SVOS on resource-constrained devices—e.g., mobile phones. Specifically, the present techniques aim to bridge the gap between memory networks with so-called infinite memory and finite memory using a knowledge distillation approach.

Advantageously, the present techniques provide an ML model that is particularly suitable for training by, and use by, constrained-resource devices. Many ML models have large backbones and so-called infinite memory requirements, but these are unsuitable for constrained-resource devices that have limited processing power/capability, limited memory, and so on. Such models lead to memory explosion and unacceptable runtime performances. In contrast, the present techniques involve training ML models that have small backbones and finite memory requirements.

However, such ML models may be less accurate than the large backbone models. Advantageously, the present techniques provide a small backbone ML model that is not only suitable for training by, and use by, constrained-resource devices but also have good accuracy which may be comparable to the accuracy achieved by large backbone models. The present techniques achieve this by having small backbone ML models that comprise two configurations—a high-resolution configuration which may be considered a “teacher”, and a low-resolution configuration which may be considered a “student”. Knowledge distillation is used between the teacher and student configurations, so that once trained, the student configuration may be used for inference tasks without any significant loss in accuracy. Importantly, instead of requiring two separate models—a teacher and a student—which would be unfeasible due to the limited storage and memory resources of constrained-resource devices, the present techniques provide a single ML model that can be made into a teacher and a student version.

Using a knowledge distillation loss may comprise using any one or more of: a cross-entropy loss, a cross-resolution loss, a boundary-aware logit loss, a representation loss, a contrastive learning loss, and an L2 distance loss. In some cases, the knowledge distillation loss may comprise multiple individual losses. As discussed below with reference to the figures, training using multiple losses may improve the overall accuracy of the training process and of the low-resolution/student configuration of the ML model.

A key part of the present techniques is in the data gathering/generation. Preferably, the source of the local training dataset is the gallery/storage of the user device itself. That is, the local training is performed using videos that users have captured themselves or videos that users have downloaded from elsewhere. In any case, the videos are in same way personal to the user of the user device.

An aim of the data generation is to generate actionable data, that is, data which can be used to train the ML model. There are at least two requirements that the data generation process needs to satisfy in order for the resulting data to be actionable data.

Firstly, it needs to be possible to divide a video into video clips that are continuous shots, i.e. which do not contain any abrupt scene changes. Thus, video clips that are generated from the stored videos comprise frames that are captured from one camera view/perspective only and do not contain any abrupt changes in object size, location, position, angle, and so on. Thus, this requirement explains how video clips may be extracted from a video. This requirement may be called “shot detection”, because the process involves extracting consecutive frames which contain smooth transitions across the frames, where these extracted frames are “shots” or “clips”.

Secondly, it needs to be possible to generate a segmentation mask from one of the frames of the video clip. That is, video clips that are generated from the stored videos need to comprise at least one frame that can be used to generate a segmentation mask. This requirement may be called “mask generation”. For example, frames which are blurry may not be suitable for generating segmentation masks because objects cannot be clearly identified within the frames.

Thus, obtaining a local training dataset comprising a plurality of video clips may comprise: obtaining a set of videos from storage of the user device; extracting at least one video clip from each video in the set of videos, where each video clip depicts a single scene from a single camera perspective and satisfies a segmentation mask generation requirement.

Extracting the at least one video clip from each video may comprise using a shot detector machine learning, ML, model.

In some cases, generating a plurality of segmentation masks may comprise generating at least one segmentation mask from each video clip using an initial frame in the video clip. That is, the first frame in the video clip may be used to generate the segmentation mask. Then, an object that appears in the initial frame can be tracked through all other frames of the video clip.

In other cases, generating a plurality of segmentation masks may comprise generating at least one segmentation mask from each video clip using a non-initial frame in the video clip. That is, any frame other than the first frame may be used to generate the segmentation mask. Then, an object that appears in this non-initial frame can be tracked through remaining frames of the video clip. This is useful in cases where an object that is desired to be tracked does not appear at the start of the video clip.

Generating at least one mask may comprise using any one or more of: user interaction, super-pixel grouping, instance segmentation, and a saliency detection. It will be understood that these are just some example, non-limiting ways to perform mask generation.

Super-pixel grouping, instance segmentation, and a saliency detection are examples of automatic methods to generate masks. No user interaction is required in these methods. Saliency detection involves detecting the most “important” object(s) in a frame, which may the most prominent object(s) in the frame, for example. This is suitable for mask generation because users are likely to want to track the most salient object(s). Super-pixel grouping involves generating super-pixels and grouping them with respect to certain statistics/characteristics (such as colour, texture, edges, etc.). Then, grouped super-pixels can be masked-out and used a segmentation mask. Instance segmentation involves generating object masks based on known object classes/class instances. This is suitable for mask generation because users are most likely to want to track common objects.

User interaction may be used instead of or in addition to the automatic methods to generate masks. User interaction may come in many different forms, such as: click; stroke; click-driven blob detection; drawing; click-driven colour segmentation; click-based super-pixel generation; and multiple clicks.

Obtaining a pre-trained global ML model comprising a high-resolution configuration and a low-resolution configuration may comprise obtaining a pre-trained global ML model from a server.

The method may further comprise transmitting the locally-trained ML model to the server for aggregation.

In a second approach of the present techniques, there is provided a user device for locally-training a machine learning, ML, model to perform video object segmentation and track one or more objects in a video, the user device comprising: storage storing a local training dataset comprising a plurality of video clips, each video clip comprising a plurality of frames; and at least one processor coupled to memory, arranged for: generating a plurality of segmentation masks, each segmentation mask corresponding to a frame of a video clip of the plurality of video clips and relating to at least one object in the frame of the video clip; obtaining a pre-trained global ML model comprising a high-resolution configuration and a low-resolution configuration; and training the pre-trained global ML model to generate a locally-trained ML model using the training dataset and the plurality of segmentation masks by: processing, using the high-resolution configuration of the global ML model, a video clip from the plurality of video clips using a segmentation mask corresponding to a frame of the video clip, and generating a first set of segmented frames based on each frame of the video clip in which the at least one object of the segmentation mask appears; generating a low-resolution version of the video clip; processing, using the low-resolution configuration of the global ML model, the low-resolution version of the video clip and the segmentation mask corresponding to the video clip, and generating a second set of segmented frames based on each frame of the low-resolution version of the video clip in which the at least one object of the segmentation mask appears; upscaling the second set of segmented frames; comparing the first set of segmented frames and the upscaled second set of segmented frames; and using a knowledge distillation loss to transfer knowledge from the high-resolution configuration to the low-resolution configuration to reduce a difference between the first set of segmented frames and the upscaled second set of segmented frames.

The features described above with respect to the first approach apply equally to the second approach and therefore, for the sake of conciseness, are not repeated.

The user device may be a constrained-resource device, but which has the minimum hardware capabilities to train a ML model and use a trained ML model. The user device may be any one of: a smartphone, tablet, laptop, computer or computing device, virtual assistant device, a vehicle, an autonomous vehicle, a robot or robotic device, a robotic assistant, image capture system or device, an augmented reality system or device, a virtual reality system or device, a gaming system, an Internet of Things device, or a smart consumer device (such as a smart fridge). It will be understood that this is a non-exhaustive and non-limiting list of example apparatuses.

The user device may further comprise a camera or image capture device for capturing/recording videos, which may then be used to generate the video clips that are used in the training method.

As noted above, the user device may receive a model to train from a central server. Thus, in a third approach of the present techniques, there is provided a computer-implemented method for training, on a server, a global machine learning, ML, model to perform video object segmentation and track one or more objects in a video, the method comprising: transmitting, to a plurality of user devices, a pre-trained global ML model comprising a high-resolution configuration and a low-resolution configuration; transmitting a request to the user devices to each train the pre-trained global ML model using local training datasets of each user device; receiving, from some or all of the plurality of user devices, the locally-trained ML models for aggregation, the locally-trained ML models comprising locally-trained high-resolution and low-resolution configurations; and combining the received high resolution configurations of the locally-trained ML models and combining the low resolution configurations of the locally-trained ML models to generate a new global ML model which outperforms the previous pre-trained global ML model.

Combining the locally-trained ML models to generate the new global ML model may involve using any suitable technique to combine the locally-trained ML models. Generally speaking, “model soups” are a recent discovery in which an ensemble of models is formed by averaging the weights of the models instead of combining each of their individual outputs. The result is a single model, which is the average of many models with many different hyperparameter configurations.

In the present techniques, a “model soup” may be used to accumulate the learning from all the user devices to obtain one global model that outperforms each individual locally-trained model.

The “model soup” pipeline may involve the following steps. Firstly, at a certain time T, the server requests model updates to be performed by a random number of user devices X. The locally-trained models are received by the server, and are temporarily saved as ingredients for the new global model. Each locally-trained model is individually validated using a global training or evaluation dataset stored on the server, which allows each local model's individual performance to be obtained. The goal is then to produce a “model soup” recipe that combines the ingredients (i.e. the individual local models) so the combination (i.e. new global model) achieves better performance than the individual local model with the best individual performance, as well as better performance than the original/previous global model. Performance may be measured in any suitable way, such as by accuracy of segmentation. Finally, the resulting new global model is distributed back to the user devices for use or further training.

One recipe for the “model soup” is referred to herein as “greedy with discrete weights”. Here, the parameters of two models are not simply combined via averaging. Instead, parameters of two models are weighted during the combining in order to obtain a better resulting combination. The models obtained from user devices are evaluated and sorted in a list according to the obtained performance. Starting from the highest performance model (prev_best), all models are traversed by combining these with the highest performance model (weighted averaging). If the combination is now better than the previous best model, the previous best model is replaced with the combination. Then the next local model in the list is used and evaluated, and the process continues until all models in the list have been evaluated.

Thus, combining the received locally-trained ML models may comprise: evaluating, using an evaluation task, each of the locally-trained ML models to determine an evaluation score for each locally-trained ML model; ordering the received locally-trained ML models in a list according to their evaluation scores; combining a locally-trained ML model from the list with the highest evaluation score with the pre-trained global ML model to generate a combined ML model; evaluating, using the evaluation task, the combined ML model to determine an evaluation score; replacing the pre-trained global ML model with the combined ML model when the evaluation score of the combined ML model is higher than an evaluation score of the pre-trained global ML model.

The method may further comprise: repeating the steps of combining, evaluation and replacing for each locally-trained ML model in the list; and transmitting the combined ML model to the user devices for use or further training.

An alternative recipe is referred to herein as a “genetic algorithm”. The “greedy with discrete weights” recipe above assumes that the server will automatically obtain a new global model that outperforms the current best performing model if the starting point is this current best performing model. However, this assumption might not be always true and thus, this alternative recipe proposes exploring many other combinations (avoiding brute force). Consider a set of models {a, . . . , x, prev_best} described in a binary vector of the same length initialized with random values [1, . . . , 0, 1]. The starting point is a population of vectors that will evolve to obtain the best possible configuration. Vectors are evaluated (a “1” represents averaging a model), selected (delete Nd worst evaluations), combined (combine Nc best models by adding or multiplying these) and mutated (fill population with modified versions of the current best combination. Each vector position has a probability P of being mutated). The cycle is repeated for Ng generation and after this, the model that performed the best is selected. The selected model will be distributed to the user devices for use/inference or further training.

Thus, combining the received locally-trained ML models may comprise weighting the contribution of each locally-trained ML model to the new global ML model, by: defining a population of binary vectors, each binary vector corresponding to one of the received locally-trained ML models, wherein each binary vector is initialised with random values; evaluating each binary vector using an evaluation task to determine an evaluation score; selecting at least two binary vectors based on the evaluation scores; and combining the selected at least two binary vectors to generate at least one combined binary vector.

The method may further comprise: deleting any non-selected binary vectors from the population; mutating the combined binary vector to generate at least one mutated binary vector; and filling at least one space in the population that arises from the deleting with the at least one mutated binary vector.

The method may further comprise: repeating the steps of evaluating, selecting and combining for the at least one mutated binary vector; and transmitting a combined ML model corresponding to the combined binary vector which performs best at the evaluation task to the user devices for use or further training.

A further alternative recipe is referred to herein as a “weighted genetic algorithm”. This is essentially an extension to the “genetic algorithm” above, where the vectors contain float values that describe the weight of each of the models averaged instead of a {0.5,0.5} averaging.

The method may further comprise generating a pre-trained global ML model by: obtaining a global training dataset comprising a plurality of video clips, each video clip comprising a plurality of frames; generating a plurality of segmentation masks, each segmentation mask corresponding to a frame of a video clip of the plurality of video clips and relating to at least one object in the frame of the video clip; obtaining a global ML model comprising a high-resolution configuration and a low-resolution configuration; and training the global ML model using the global training dataset and the plurality of segmentation masks by: processing, using the high-resolution configuration of the ML model, a video clip from the plurality of video clips using a segmentation mask corresponding to the video clip, and generating a first set of segmented frames based on each frame of the video clip in which the at least one object of the segmentation mask appears; generating a low-resolution version of the video clip; processing, using the low-resolution configuration of the ML model, the low-resolution version of the video clip and the segmentation mask corresponding to the video clip, and generating a second set of segmented frames based on each frame of the low-resolution version of the video clip in which the at least one object of the segmentation mask appears; upscaling the second set of segmented frames; comparing the first set of segmented frames and the upscaled second set of segmented frames; and using a knowledge distillation loss to transfer knowledge from the high-resolution configuration to the low-resolution configuration to reduce a difference between the first set of segmented frames and the upscaled second set of segmented frames.

In a fourth approach of the present techniques, there is provided a server for training a global machine learning, ML, model to perform video object segmentation and track one or more objects in a video, the server comprising: at least one processor coupled to memory, arranged for: transmitting, to a plurality of user devices, a pre-trained global ML model comprising a high-resolution configuration and a low-resolution configuration; transmitting a request to the user devices to each train the pre-trained global ML model using local training datasets of each user device; receiving, from some or all of the plurality of user devices, the locally-trained ML models for aggregation, the locally-trained ML models comprising locally-trained high-resolution and low-resolution configurations; and combining the received high-resolution configurations of the locally-trained ML models and combining the low-resolution configurations of the locally-trained ML models to generate a new global ML model which outperforms the previous pre-trained global ML model.

The features described above with respect to the third approach apply equally to the fourth approach and therefore, for the sake of conciseness, are not repeated.

In a fifth approach of the present approach, there is provided a system for training a global machine learning, ML, model to perform video object segmentation and track one or more objects in a video, the system comprising: a server and a plurality of user devices. The number of user devices may be tens, hundreds, thousands, hundreds of thousands, or more.

The server comprises at least one processor coupled to memory, arranged for: transmitting, to a plurality of user devices, a pre-trained global ML model comprising a high-resolution configuration and a low-resolution configuration; and transmitting a request to the user devices to each train the pre-trained global ML model using local training datasets of each user device.

Each user device may comprise storage storing a local training dataset comprising a plurality of video clips, each video clip comprising a plurality of frames; and at least one processor coupled to memory, arranged for: generating a plurality of segmentation masks, each segmentation mask corresponding to a frame of a video clip of the plurality of video clips and relating to at least one object in the frame of the video clip; obtaining a pre-trained global ML model comprising a high-resolution configuration and a low-resolution configuration; and training the pre-trained global ML model to generate a locally-trained ML model using the training dataset and the plurality of segmentation masks by: processing, using the high-resolution configuration of the global ML model, a video clip from the plurality of video clips using a segmentation mask corresponding to a frame of the video clip, and generating a first set of segmented frames based on each frame of the video clip in which the at least one object of the segmentation mask appears; generating a low-resolution version of the video clip; processing, using the low-resolution configuration of the global ML model, the low-resolution version of the video clip and the segmentation mask corresponding to the video clip, and generating a second set of segmented frames based on each frame of the low-resolution version of the video clip in which the at least one object of the segmentation mask appears; upscaling the second set of segmented frames; comparing the first set of segmented frames and the upscaled second set of segmented frames; and using a knowledge distillation loss to transfer knowledge from the high-resolution configuration to the low-resolution configuration to reduce a difference between the first set of segmented frames and the upscaled second set of segmented frames.

The server may be further configured for: receiving, from some or all of the plurality of user devices, the locally-trained ML models for aggregation, the locally-trained ML models comprising locally-trained high-resolution and low-resolution configurations; and combining the received high resolution configurations of the locally-trained ML models and combining the low resolution configurations of the locally-trained ML models to generate a new global ML model which outperforms the previous pre-trained global ML model.

The features described above with respect to the first to fourth approaches apply equally to the fifth approach and therefore, for the sake of conciseness, are not repeated.

Thus far, training of the ML model has been described. The new global ML model which results from the training is provided to each user device for use on-device.

In a sixth approach of the present techniques, there is provided a computer-implemented method for using a trained machine learning, ML, model to perform video object segmentation and track one or more objects in a video, the method comprising: obtaining a video clip comprising a plurality of frames and an object to be tracked through the frames; generating a segmentation mask for the object to be tracked based on a frame depicting the object; inputting the video and initial mask into a low resolution configuration of the trained ML model that has been trained according to any of the methods described herein; and outputting, from the low resolution configuration of the trained ML model, at least one segmented frame in which the object is segmented from the other objects in the frame.

The method may further comprise: generating augmented frames from the segmented frames.

Generating augmented frames from the segmented frames may comprise performing any one or more of: inpainting, compositing, stylisation, and focusing.

As will be appreciated by one skilled in the art, the present techniques may be embodied as a system, method or computer program product. Accordingly, present techniques may take the form of an entirely hardware embodiment, an entirely software embodiment, or an embodiment combining software and hardware aspects.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

Embodiments of the present techniques also provide a non-transitory data carrier carrying code which, when implemented on a processor, causes the processor to carry out any of the methods described herein.

The techniques further provide processor control code to implement the above-described methods, for example on a general purpose computer system or on a digital signal processor (DSP). The techniques also provide a carrier carrying processor control code to, when running, implement any of the above methods, in particular on a non-transitory data carrier. The code may be provided on a carrier such as a disk, a microprocessor, CD- or DVD-ROM, programmed memory such as non-volatile memory (e.g. Flash) or read-only memory (firmware), or on a data carrier such as an optical or electrical signal carrier. Code (and/or data) to implement embodiments of the techniques described herein may comprise source, object or executable code in a conventional programming language (interpreted or compiled) such as Python, C, or assembly code, code for setting up or controlling an ASIC (Application Specific Integrated Circuit) or FPGA (Field Programmable Gate Array), or code for a hardware description language such as Verilog (RTM) or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

It will also be clear to one of skill in the art that all or part of a logical method according to embodiments of the present techniques may suitably be embodied in a logic apparatus comprising logic elements to perform the steps of the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the present techniques may be realised in the form of a data carrier having functional data thereon, said functional data comprising functional computer data structures to, when loaded into a computer system or network and operated upon thereby, enable said computer system to perform all the steps of the above-described method.

The method described above may be wholly or partly performed on an apparatus, i.e. an electronic device, using a machine learning or artificial intelligence model. The model may be processed by an artificial intelligence-dedicated processor designed in a hardware structure specified for artificial intelligence model processing. The artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training algorithm. The artificial intelligence model may include a plurality of neural network layers. Each of the plurality of neural network layers includes a plurality of weight values and performs neural network computation by computation between a result of computation by a previous layer and the plurality of weight values.

As mentioned above, the present techniques may be implemented using an AI model. A function associated with AI may be performed through the non-volatile memory, the volatile memory, and the processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or artificial intelligence (AI) model stored in the non-volatile memory and the volatile memory. The predefined operating rule or artificial intelligence model is provided through training or learning. Here, being provided through learning means that, by applying a learning algorithm to a plurality of learning data, a predefined operating rule or AI model of a desired characteristic is made. The learning may be performed in a device itself in which AI according to an embodiment is performed, and/o may be implemented through a separate server/system.

The AI model may consist of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

### BRIEF DESCRIPTION OF THE DRAWINGS

Implementations of the present techniques will now be described, by way of example only, with reference to the accompanying drawings, in which:

FIG. 1A shows how a mask may be generated from a frame (which may be the first frame or another frame) of a video;

FIG. 1B shows how masks for different objects may be generated and used to track those objects through frames of a video;

FIG. 1C depicts video inpainting;

FIG. 2 is a schematic diagram illustrating various components of the present techniques;

FIG. 3 is a flowchart of example steps for locally-training, on a user device, a machine learning, ML, model to perform video object segmentation and track one or more objects in a video;

FIG. 4 shows the knowledge/memory distillation technique in more detail;

FIG. 5A is a schematic diagram showing the present data generation process;

FIG. 5B is a schematic diagram showing the shot detection process;

FIG. 6A is a schematic diagram showing how segmentation masks may be generated;

FIG. 6B shows example ways that user interaction may be used instead of or in addition to the automatic methods to generate masks;

FIG. 7 is a flowchart of example steps for training, on a server, a global machine learning, ML, model to perform video object segmentation and track one or more objects in a video;

FIG. 8A is a schematic diagram illustrating the model soup concept;

FIG. 8B is a schematic diagram illustrating the genetic algorithm;

FIG. 9 shows a table of results on DAVIS'17.

FIG. 10 shows a table of results on DAVIS'16;

FIG. 11 shows a comparison of the present techniques against other state-of-the-art methods on the large-scale YouTube-VOS 2019 validation set;

FIG. 12 shows that the present technique is significantly faster than others, and also significantly smaller;

FIG. 13 shows model latency against queue sizes between 1 and 20;

FIG. 14 shows that both Llogit and Lrepr introduce improvements, especially the newly formulated Lrepr;

FIG. 15 shows an result of an experiment that demonstrating the performance improvement attributed to sampling boundary pixels;

FIG. 16 is a flowchart of example steps for using a trained machine learning, ML, model to perform video object segmentation and track one or more objects in a video, the method comprising.

### DETAILED DESCRIPTION

Broadly speaking, the present techniques provide methods for training ML models to track an object through frames of a video even when the object may change shape, orientation, position, proximity and angle to a camera that captured the video, and so on.

Semi-supervised video object segmentation, SVOS, aims to track a mask/segmentation mask throughout a video clip. This is often called one-shot video segmentation. Unlike conventional video object segmentation, VOS, SVOS uses a mask generated from a frame to track an object corresponding to the mask across the video. SVOS predicts a binary mask for each initial mask across a video, and models the motion and the appearance changes across time. There are no “semantics” involved, at least not as much as conventional VOS. SVOS does not detect the first frame mask. The initial mask can be provided by any mask prediction method; including but not limited to saliency, semantic segmentation, object grouping, alpha mattes, etc. SVOS methods can track one or multiple objects across the video. Initial mask(s) can also be provided in the middle of a video.

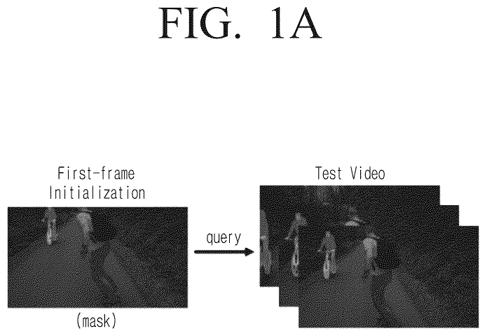

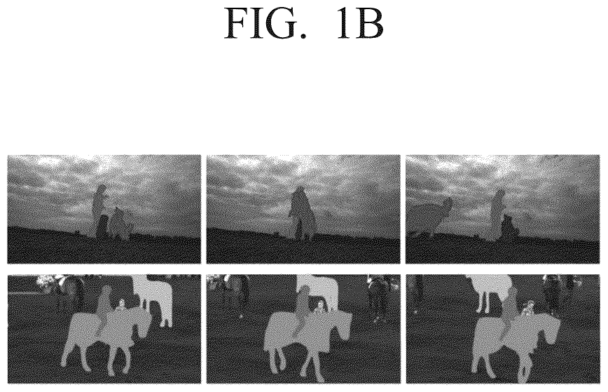

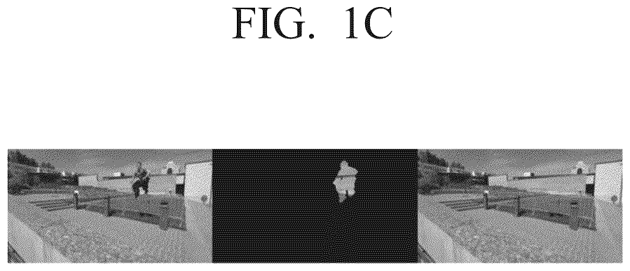

FIG. 1A shows how a mask may be generated from a frame (which may be the first frame or another frame) of a video. Here, the mask (left) may correspond to one or both of the people. The mask is then used to identify and track one or both of the people in the subsequent frames (right) of the video.

FIG. 1B shows how masks for different objects may be generated and used to track those objects through frames of a video. In the top set of frames, there are three masked objects—one person, and two dogs. It can be seen how SVOS can track each object even when the location, shape, size, position, angle and so on of the object changes across frames. In the bottom set of frames, there are three masked objects—a horse rider and two horses. Other objects in the frames are ignored.

SVOS is an integral part of a multitude of video editing and video production tasks. One example, non-limiting use is video inpainting, where a foreground object, that is segmented via a segmentation mask, is removed, and the removed object is filled-in to match the remainder of the image/frame. FIG. 1C depicts video inpainting. The inpainting may be a technique in which portions of damaged (or broken) images are reconstructed (or restored) by interpolation of surrounding areas corresponding to the portions of damaged images. In the leftmost image, a person is seen jumping. This person is a foreground object and a segmentation mask (middle) for the foreground object enables the person to be removed from all frames in which the person appears. Once the person has been removed, the gap in each frame which arises, is in-filled to match the background, as shown in the rightmost image. Video inpainting may be used for object removal and/or video manipulation. Other example, non-limiting uses include: video compositing, where the foreground of an image/video is copied to another video, which may be used for video production and/or video manipulation; video stylization, where the part of the video tracked with SVOS is stylized, which may be used for visual effects and/or content creation; and video focusing, where the focus area (tracked by SVOS) of the video is dynamically changed, which may be used for creating a Bokeh effect.

Existing SVOS methods find feature correspondences across frames of a video; it is essentially a feature matching problem. Many SVOS methods use online adaptation; they finetune their models on test videos, which is inherently not feasible. Correlation filter-based and pure mask propagation methods are used as well. However, these methods suffer from the inherent issues of template matching; the templates are either limited in expressivity, or not updated efficiently.

A promising branch of SVOS methods use memory networks; such methods keep a memory of reference frames to guide the feature matching to predict the next mask. By dynamically updating/populating the memory, appearance and motion changes are modelled effectively, often better than other methods.

However, none of the existing methods are suitable for on-device deployment. Existing methods either require per-scene on-device training or are not accurate enough. Memory networks address both these problems, but they have their own challenges. For example, memory networks often use every frame as reference frame (i.e. infinite memory), which means the memory bank becomes bigger as the tracking progresses through a video. This consumes a lot of memory and reduces the runtime performance. Accurate memory network methods use large backbone models to extract features for correspondence, which lowers their feasibility for on-device operation.

Even the most “lightweight” model in the literature is not good enough. Such a model operates at a maximum of 80 FPS on high-end desktop GPUs, uses complex backbones that do not map well to on-device accelerators, and depends on complex gating mechanisms to update the primary template in the memory. Using infinite queue models leads to gradual degradation in both performance and runtime.

Furthermore, existing SVOS methods do not leverage user data. SVOS performance, like other ML-based methods, can scale its performance with additional, diverse data. This is especially important in SVOS; although SVOS is supposed to be class-agnostic, in practice it is not. For example, evaluation of the YouTube SVOS dataset shows that all methods often do worse in unseen class SVOS performance compared to seen class performance.

Existing methods are trained offline on fixed datasets, therefore their performance in inherently limited. Such offline training will make the model prone to distribution shifts as well. Distribution shift occurs when test data changes in distribution over time, and the offline trained model becomes less and less accurate.

Existing SVOS methods do not leverage user interaction/feedback. For training SVOS networks on-device, it is necessary to generate ground-truth labels. However, there is typically no on-device sensor to generate ground-truth labels for video matting, unlike for depth estimation (stereo cameras, ToF), tilt estimation (IMUs), etc.

Furthermore, user interaction is quite useful and can be used to generate ground-truth labels for on-device training. However, user input can only give a number of labels; i.e. the first label mask. It is necessary to provide video-wide labels; i.e. labels are needed for all frames of a video. However, there is no on-device sensor to generate these labels for SVOS.

Thus, there are a number of problems with existing techniques. As explained in more detail below, the present techniques adopt a memory-network based approach since high accuracy tracking is required and is desirable to design the memory banks to fit on-device needs.

The present techniques also use user data for on-device training, which addresses some of the above issues, and unlocks important features, such as personalized performance due to training with user data, increased performance due to additional data, increased performance due to robustness to distribution shifts, and closer performance in seen and unseen classes.

The present techniques also enable user input/interaction to provide ground-truth labels for SVOS. Furthermore, user interaction can be used for improving the results of SVOS.

As will be familiar to those in the art, Knowledge Distillation (KD) uses the predictions of a larger model (teacher) to provide additional supervision to a much smaller model (student) during training. KD is a typically used for model compression, making it useful for deployment scenarios. Its usage was first proposed in the context of image classification and has since been extended to depth estimation, segmentation, object detection and image translation tasks. The present techniques also make use of knowledge distillation. Distillation methods use a trained “teacher” model to generate pseudo-labels over the training data. This is especially useful when ground-truth data is not available, as is the case here. The present techniques propose distilling the knowledge of a teacher model to a “student” model to facilitate on-device training.

The present techniques aim to bridge the performance gap between small finite memory space-time networks and their large infinite memory counterparts. The present techniques open the possibility for real-time high quality video object segmentation on resource-constrained devices, such as mobile phones. The present techniques broadly apply a knowledge distillation approach with advantageous extensions such as contrastive learning and boundary aware sampling. Although the following focusses on semi-supervised video object segmentation, it is expected that the described framework may be applicable to other dense prediction tasks.

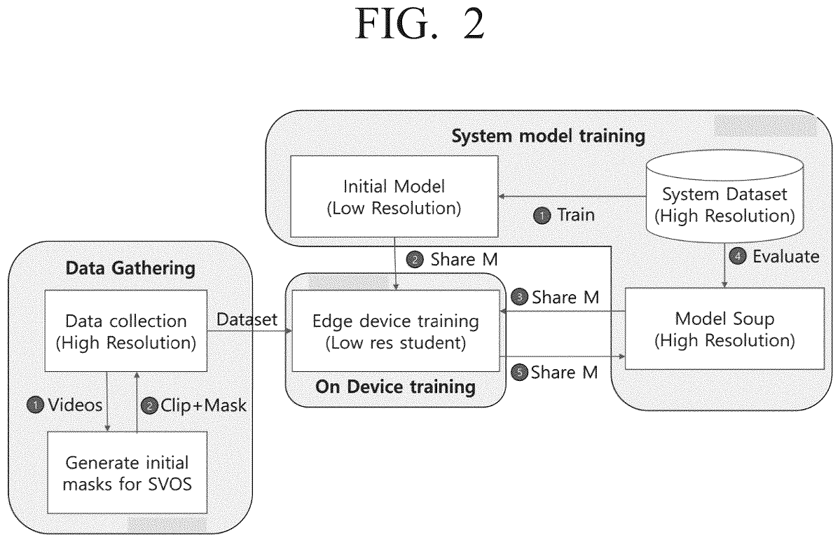

FIG. 2 is a schematic diagram illustrating various components of the present techniques. Each component is described below in more detail. One component of the present techniques is data gathering. This involves obtaining useful information from user data. Data is maintained privately in the user's device. Gathered data is used to train the SVOS model on-device. Another component is on-device training, where a model is trained using low-resolution inputs while evaluating in a high-resolution dataset using a unique combination of Knowledge distillation losses. Another component is system model training. This is divided into two parts: initial training model, which consists of a typical supervised training paradigm, where the trained model is shared with the edge/user devices; and a “model soup” (or update & share process), where a variety of models are selected from a random set of edge devices. A model soup strategy may be applied using the system dataset to evaluate the generated models. The best model generated via the “model soup” recipe is shared with the edge/user devices.

### On-Device Training

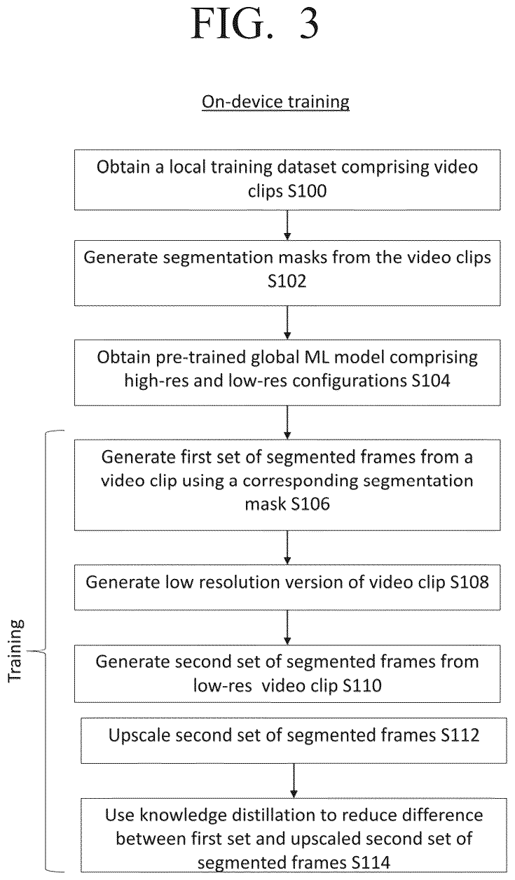

FIG. 3 is a flowchart of example steps for locally-training, on a user device, a machine learning, ML, model to perform video object segmentation and track one or more objects in a video.

The method comprises obtaining a local training dataset comprising a plurality of video clips, each video clip comprising a plurality of frames (step S100). The video clips may be generated from videos stored in a local storage on the user device (e.g., mobile phone)—i.e., a storage local to the device the method is being implemented on—or from some other suitable source such as online repository. Generally, the present techniques aim to solve problems of on-device deployment, and so in the following videos obtained from local storage, particularly those from a mobile phone, as might be collated by a Gallery App, are assumed.

Preferably the video clips comprise a sequence of frames that is temporally consecutive, such that there is expected to be a smooth transition of objects from frame to frame. For example, a sequence of frames in which an object does not change size or location abruptly, and the camera viewpoint is generally consistent. This is described in more detail below in the section on video clip generation.

The method comprises generating a plurality of segmentation masks, each segmentation mask corresponding to a frame of a video clip of the plurality of video clips and relating to at least one object in the frame of the video clip (step S102). The segmentation mask, alternatively termed a label, is generated for an object present in a frame of the video clip. The mask/label indicates the object which is to be tracked through the sequence of video frames. Preferably the objects correspond to a physical feature shown in the image, as opposed to a randomly selected area. This step concerns segmentation mask generation and is described in more detail below.

The method comprises obtaining a pre-trained global ML model comprising a high-resolution configuration and a low-resolution configuration (step S104). As shown in FIG. 3, the global ML model may be received from a server.

The method comprises training the pre-trained global ML model to generate a locally-trained ML model using the local training dataset and the plurality of segmentation masks by. The training comprises processing, using the high-resolution configuration of the global ML model, a video clip from the plurality of video clips using a segmentation mask corresponding to a frame of the video clip, and generating a first set of segmented frames based on each frame of the video clip in which the at least one object of the segmentation mask appears (step S106). The training comprises: generating a low-resolution version of the video clip (step S10); and processing, using the low-resolution configuration of the global ML model, the low-resolution version of the video clip and the segmentation mask corresponding to the video clip, and generating a second set of segmented frames based on each frame of the low-resolution version of the video clip in which the at least one object of the segmentation mask appears (step S110). The training comprises upscaling the second set of segmented frames (step S112). The upscaling may involve reverse and performing the inverse of the technique to generate the low resolution or downscaled version of the video clip at step S108.

The training comprises: comparing the first set of segmented frames and the upscaled second set of segmented frames; and using a knowledge distillation loss to transfer knowledge from the high-resolution configuration to the low-resolution configuration to reduce a difference between the first set of segmented frames and the upscaled second set of segmented frames (step S114). Using a knowledge distillation loss may comprise using any one or more of: a cross-entropy loss, a cross-resolution loss, a boundary-aware logit loss, a representation loss, a contrastive learning loss, and an L2 distance loss. In some cases, the knowledge distillation loss may comprise multiple individual losses. As discussed below with reference to the Figures, training using multiple losses may improve the overall accuracy of the training process and of the low-resolution/student configuration of the ML model.

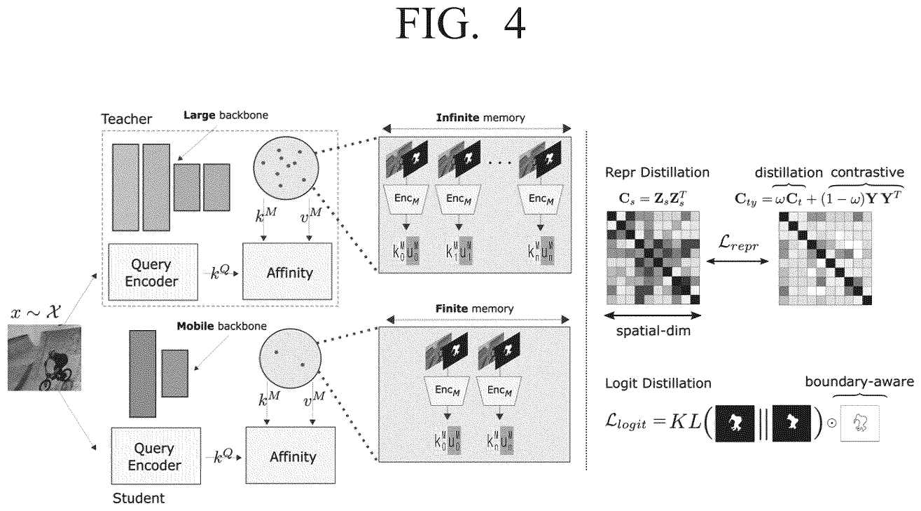

FIG. 4 shows the knowledge/memory distillation technique in more detail. In the following, it is taken that representation distillation is used just before the final fully connected layer in the ML model. Using earlier layers may hurt the student model's performance due to differing inductive biases and subsequent collapsing of the output space losing structural information that can benefit the knowledge transfer.

Suitably, the present techniques utilise essentially a pixel-wise representation distillation loss that can transfer the structural information between the teacher and student models. The same training data are fed into both networks and a distillation loss is applied at the representation level. To extract structural information, correlation matrices Cₛ, Cₜ∈ [symbol] may be constructed which capture the relationship between all pairs of pixels as:

$${C}_{s} = {Z}_{S} {Z}_{S}^{T} \qquad ( 1 )$$

$${C}_{t} = {Z}_{T} {Z}_{T}^{T} \qquad ( 2 )$$

where Z_{S}∈ [symbol] ^{HW×C}^{_{S}} and Z_{T}∈ [symbol] ^{HW×C}^{_{T}} denote the student and teacher representations respectively. In the current example these are specifically L2 normalised student and teacher representations provided before the final point-wise convolution and, if present, upsampling layers. Suitably, the final representation loss may be given as follows:

$${ℒ}_{repr} = \frac{1}{\vert C \vert} ( {log}_{2} {‖ {C}_{s} ‖}_{F}^{2} - {log}_{2} {‖ {C}_{s} ⊙ {C}_{t} ‖}_{F}^{2} ) \qquad ( 3 )$$

where ⊙ is the Hadamard product. The two components of this loss can be interpreted as a regularisation term, and a correlation alignment between the two models, while the log 2 operator is used here to improve the robustness to spurious correlations. An interesting property of this loss formulation is that it is equivalent to maximising the pixel-wise mutual information between the student and teacher representations

$${ℒ}_{repr} \to {ℒ}_{mi} = {H}_{2} ( {Z}_{S} ) - {H}_{2} ( {Z}_{S} ; {Z}_{T} ) \qquad ( 4 )$$

$$= - {I}_{2} ( {Z}_{S} ; {Z}_{T} ) \qquad ( 5 )$$

where H2 and I2 are matrix-based estimators resembling Renyi's entropy and mutual information of order 2 respectively. From this perspective, the two terms can instead be interpreted as maximising the joint entropy subject to an entropy regularisation.

In other words, the ML model may be suitably trained by determining cross entropy loss between the teacher ML model and student ML model. That is, the ML model may be trained using the Lrepr loss, such as in the form of eq. (3) or (4), alone or in combination with other loss functions.

It has also been determined that the effectiveness of knowledge distillation can be dependent on the relative capacity gap between the student and teacher models. More formally, a teacher-student training regime scales poorly as the capacity gap diminishes. To address this, equation (3) may be further revised to encompass pixel-wise contrastive learning. it is believed this is the first ever work to unify representation distillation with contrastive learning.

In this example, an additional target correlation matrix (Cy)ij∈{0, 1} is constructed as follows:

$${C}_{y} = {YY}^{T} \qquad ( 6 )$$

where Y∈IR are spatially-downsampled one-hot encoded labels for the object and background. The two training regimes (i.e., distillation and contrastive learning) may be interpolated between by providing target correlation matrices

$${C}_{ty} = ω {C}_{t} + ( 1 - ω ) {YY}^{T} \qquad ( 7 )$$

where ω∈[0, 1] is a hyperparameter and Cty can now be substituted into equation (3). By considering a representation Z and the case where ω=0, the loss will reduce to a supervised contrastive setting:

$${ℒ}_{repr} \to {ℒ}_{SupCon} = - \frac{1}{\vert C \vert} {log}_{2} {\sum }_{i} \frac{{\sum }_{j ∈ {𝒫}_{i}} sim ( {Z}_{i} , {Z}_{j} )}{{\sum }_{k} sim ( {Z}_{i} , {Z}_{k} )} \qquad ( 8 )$$

where sim is the cosine similarity between two individual pixels in a representation and Pi is the set of positive indices for i-th pixel (see Supplementary for derivation). Intuitively, for a given pixel, the numerator attracts the positives, while the denominator repels the negatives. Suitably, the representation distillation can now be interpreted as a heuristic hard mining strategy for the contrastive component of the loss. The connection between these two regimes is illustrated in the following:

$${ℒ}_{mi} {←}^{ω = 0} {ℒ}_{repr} {\to }^{ω = 1} {ℒ}_{SupCon} \qquad ( 9 )$$

where the choice of ω is motivated by the availability and relative performance of a pre-trained teacher model. In other words, the representation distillation loss may include determining either one, or a combination, of pixel wise mutual information loss Lmi between the teacher ML model and student ML model and supervised contrastive representation loss Lsupcon.

A potential downside of the above techniques is that they construct the correlation matrices for all pixels, which is computationally expensive. Notably, it has been determined that most prediction errors occur on the boundary of objects.

The above technique may be modified by only sampling object boundary pixels. Such a sampling strategy restricts the distillation gradients to only flow through pixels that lead to downstream prediction errors, while also enabling a much more computationally efficient formulation. Since each frame also has a different boundary, the normalisation term (Equation3) now averages over the size of these object boundaries, thus allowing the loss to naturally uniformly weight both small and large objects evenly. It is additionally observed that this modification can improve the overall model convergence/

Moreover, logit distillation may be applied using the pixels around of near the boundary of objects, which may further improve the training accuracy. Here an additional KL divergence term may be introduced at the logit space between the two models:

$${ℒ}_{logit} = \frac{1}{HW} \sum KL ( {p}_{S} ( τ ) ‖ {p}_{T} ( τ ) ) \qquad ( 10 )$$

where pS, pT are the student and teacher probabilities parameterised by a term τ for softening (τ>1) or sharpening (τ<1) the two predictions. In such an example, the final loss may be given as:

$$ℒ = {ℒ}_{XE} + {ℒ}_{logit} + {ℒ}_{repr} \qquad ( 11 )$$

### Video Clip Generation

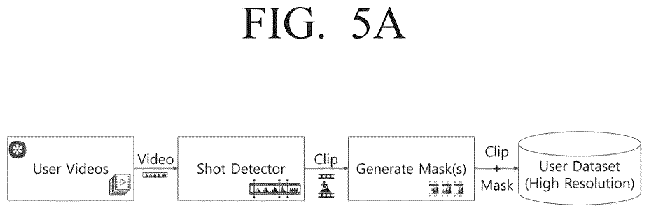

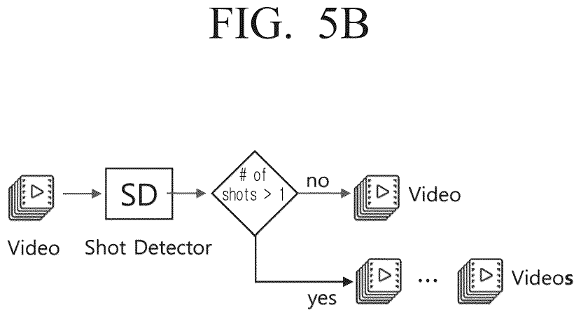

FIG. 5A is a schematic diagram showing the present data generation process. A key part of the present techniques is in the data gathering/generation. Preferably, the source of the local training dataset is the gallery/storage of the user device itself. That is, the local training is performed using videos that users have captured themselves or videos that users have downloaded from elsewhere. In any case, the videos are in same way personal to the user of the user device.

An aim of the data generation is to generate actionable data, that is, data which can be used to train the ML model. There are at least two requirements that the data generation process needs to satisfy in order for the resulting data to be actionable data.

Firstly, it needs to be possible to divide a video into video clips that are continuous shots, i.e. which do not contain any abrupt scene changes. Thus, video clips that are generated from the stored videos comprise frames that are captured from one camera view/perspective only and do not contain any abrupt changes in object size, location, position, angle, and so on. Thus, this requirement explains how video clips may be extracted from a video. This requirement may be called “shot detection”, because the process involves extracting consecutive frames which contain smooth transitions across the frames, where these extracted frames are “shots” or “clips”.

Secondly, it needs to be possible to generate a segmentation mask from one of the frames of the video clip. That is, video clips that are generated from the stored videos need to comprise at least one frame that can be used to generate a segmentation mask. This requirement may be called “mask generation”. For example, frames which are blurry may not be suitable for generating segmentation masks because objects cannot be clearly identified within the frames.

Thus, step S100 in FIG. 3 of obtaining a local training dataset comprising a plurality of video clips may comprise: obtaining a set of videos from storage of the user device; extracting at least one video clip from each video in the set of videos, where each video clip depicts a single scene from a single camera perspective and satisfies a segmentation mask generation requirement.

Extracting the at least one video clip from each video may comprise using a shot detector machine learning, ML, model. FIG. 5B is a schematic diagram showing the shot detection process. SVOS dictates a requirement for a smooth transition across frames; i.e. an object will not change its size or location immediately. In other words, the camera viewpoint will not change abruptly either. Such sequences are defined as “shots/clips”. Many videos tend to be formed of multiple shots. Such videos cannot be used as training data for the present techniques. Therefore, such videos are divided into shots or video clips with a shot detector model. If the video is formed of a single shot, shot detector will not detect shots. If the video is formed of multiple shots, multiple actionable videos/shots may be generated. Any suitable shot detection model may be used, such as the shot detection model described in Chen, Shixing, et al. “Shot contrastive self-supervised learning for scene boundary detection.” Proceedings of the IEEE/CVF Conference on Computer Vision and Pattern Recognition. 202.

### Segmentation Mask Generation

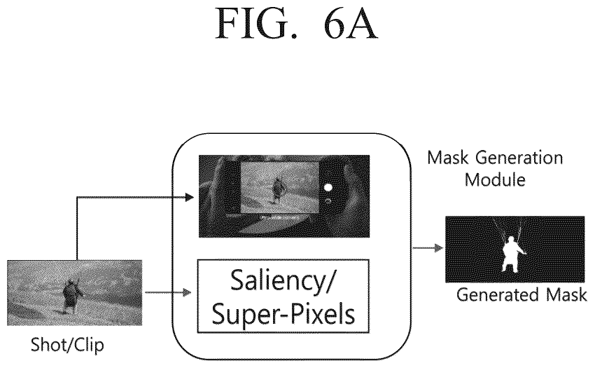

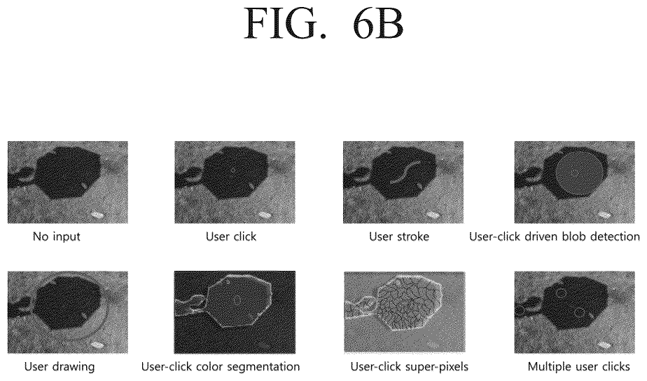

FIG. 6A is a schematic diagram showing how segmentation masks may be generated. Once the video clips have been generated, it is necessary to generate a segmentation mask from one (or more) of the frames of each video clip. The segmentation masks correspond to the object SVOS will track. Preferably, the segmentation masks correspond to “objects” and not random areas.

In some cases, step S102 in FIG. 3 of generating a plurality of segmentation masks may comprise generating at least one segmentation mask from each video clip using an initial frame in the video clip. That is, the first frame in the video clip may be used to generate the segmentation mask. Then, an object that appears in the initial frame can be tracked through all other frames of the video clip.

In other cases, step S102 of generating a plurality of segmentation masks may comprise generating at least one segmentation mask from each video clip using a non-initial frame in the video clip. That is, any frame other than the first frame may be used to generate the segmentation mask. Then, an object that appears in this non-initial frame can be tracked through remaining frames of the video clip. This is useful in cases where an object that is desired to be tracked does not appear at the start of the video clip.

The segmentation masks may be generated in many different ways, including user interaction, super-pixel grouping, interactive segmentation, saliency detectors, etc. Note that with the present data gathering pipeline, personalization is achieved in potentially in two ways: data personalization, since the videos used to create shots are videos that are kept/stored and therefore liked by the user; and mask personalization, since user interaction will provide user preferences, and will lead to further personalization.

Generating at least one mask may comprise using any one or more of: user interaction, super-pixel grouping, instance segmentation, and a saliency detection. It will be understood that these are just some example, non-limiting ways to perform mask generation.

Super-pixel grouping, instance segmentation, and a saliency detection are examples of automatic methods to generate masks. No user interaction is required in these methods. Saliency detection involves detecting the most “important” object(s) in a frame, which may the most prominent object(s) in the frame, for example. This is suitable for mask generation because users are likely to want to track the most salient object(s). Super-pixel grouping involves generating super-pixels and grouping them with respect to certain statistics/characteristics (such as colour, texture, edges, etc.). Then, grouped super-pixels can be masked-out and used a segmentation mask. Instance segmentation involves generating object masks based on known object classes/class instances. This is suitable for mask generation because users are most likely to want to track common objects.

FIG. 6B shows example ways that user interaction may be used instead of or in addition to the automatic methods to generate masks. User interaction may come in many different forms, such as: clicking an area in a frame; stroke; click-driven blob detection; drawing a boundary; click-driven colour segmentation; click-based super-pixel generation; and multiple clicks. It will also be appreciated that certain user interactions may also be enhanced by ML techniques, for example colour segmentation or super pixels.

The video clips and corresponding segmentation masks can now be paired/grouped together and used for the training steps in FIG. 3. One advantage of using locally stored videos is that the training data will be formed of a suitably high-resolution data set. Also, the present techniques may be suitably adapted to prioritise training on user videos which are determined to be more important, or useful, to train on. For example, user videos which have been edited by a user (for example, applying a filter, including possibly some sort of mask) may be tagged as high priority for training. Suitably, the trained ML model may be tuned to a specific user.

### Server Training

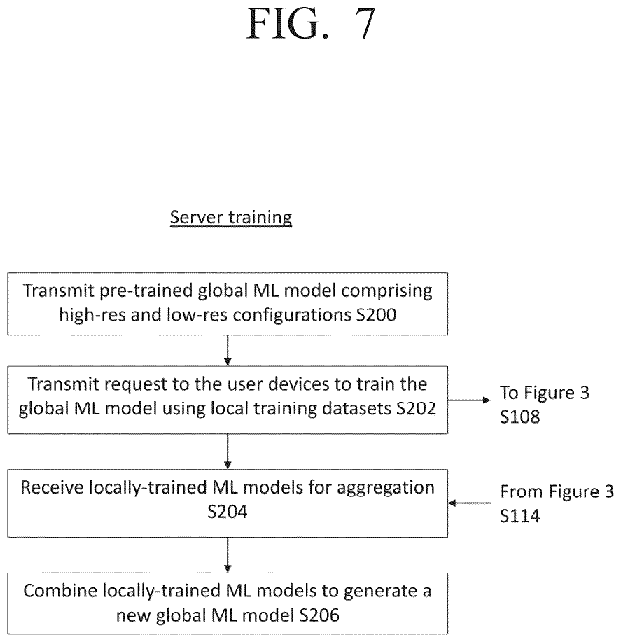

FIG. 7 is a flowchart of example steps for training, on a server, a global machine learning, ML, model to perform video object segmentation and track one or more objects in a video.

The method comprises: transmitting, to a plurality of user devices, a pre-trained global ML model comprising a high-resolution configuration and a low-resolution configuration (step S200). As mentioned above, at some predetermined time point, the method comprises transmitting a request to some or all of the user devices to each train the pre-trained global ML model using local training datasets of each user device (step S202). The training is now performed by the local devices as per the method shown in FIG. 3.

The method comprises receiving, from some or all of the plurality of user devices, the locally-trained ML models for aggregation, the locally-trained ML models comprising locally-trained high-resolution and low-resolution configurations (step S204).

The method comprises combining the received high resolution configurations of the locally-trained ML models and combining the low resolution configurations of the locally-trained ML models to generate a new global ML model which outperforms the previous pre-trained global ML model (step S206).

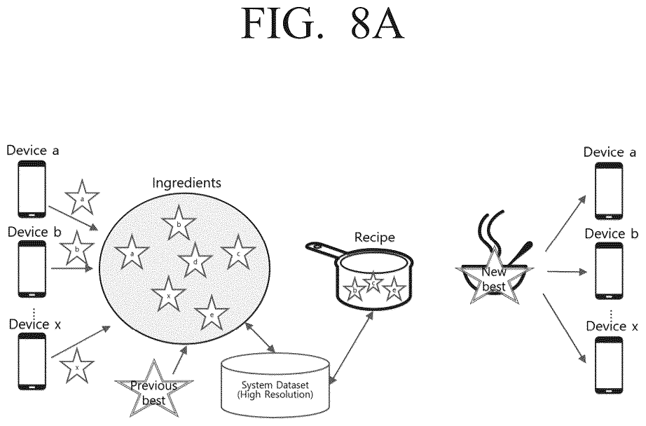

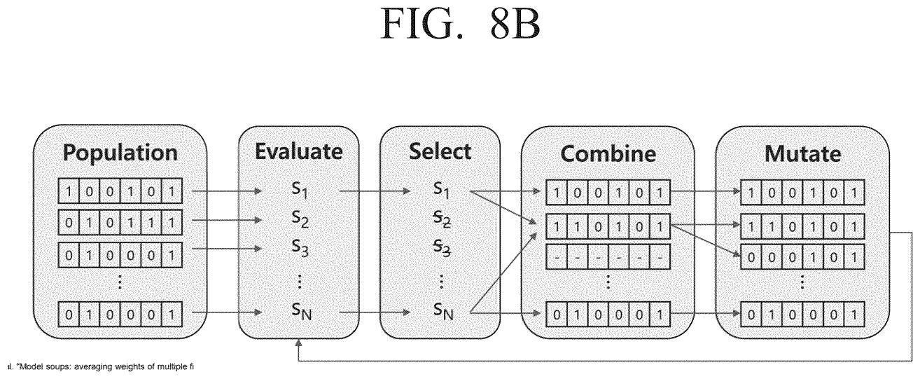

Combining the locally-trained ML models to generate the new global ML model may involve using any suitable technique to combine the locally-trained ML models. Generally speaking, “model soups” are a recent discovery in which an ensemble of models is formed by averaging the weights of the models instead of combining each of their individual outputs. The result is a single model, which is the average of many models with many different hyperparameter configurations. FIG. 8A is a schematic diagram illustrating the model soup concept.

In the present techniques, a “model soup” may be used to accumulate the learning from all the user devices to obtain one global model that outperforms each individual locally-trained model.

The “model soup” pipeline may involve the following steps. Firstly, at a certain time T, the server requests model updates to be performed by a random number of user devices X. The locally-trained models are received by the server, and are temporarily saved as ingredients for the new global model. Each locally-trained model is individually validated using a global training or evaluation dataset stored on the server, which allows each local model's individual performance to be obtained. The goal is then to produce a “model soup” recipe that combines the ingredients (i.e. the individual local models) so the combination (i.e. new global model) achieves better performance than the individual local model with the best individual performance, as well as better performance than the original/previous global model. Performance may be measured in any suitable way, such as by accuracy of segmentation. Finally, the resulting new global model is distributed back to the user devices for use or further training.

One recipe for the “model soup” is referred to herein as “greedy with discrete weights”. Here, the parameters of two models are not simply combined via averaging. Instead, parameters of two models are weighted during the combining in order to obtain a better resulting combination. The models obtained from user devices are evaluated and sorted in a list according to the obtained performance. Starting from the highest performance model (prev_best), all models are traversed by combining these with the highest performance model (weighted averaging). If the combination is now better than the previous best model, the previous best model is replaced with the combination. Then the next local model in the list is used and evaluated, and the process continues until all models in the list have been evaluated.

Thus, combining the received locally-trained ML models may comprise: evaluating, using an evaluation task, each of the locally-trained ML models to determine an evaluation score for each locally-trained ML model; ordering the received locally-trained ML models in a list according to their evaluation scores; combining a locally-trained ML model from the list with the highest evaluation score with the pre-trained global ML model to generate a combined ML model; evaluating, using the evaluation task, the combined ML model to determine an evaluation score; replacing the pre-trained global ML model with the combined ML model when the evaluation score of the combined ML model is higher than an evaluation score of the pre-trained global ML model.

The method may further comprise: repeating the steps of combining, evaluation and replacing for each locally-trained ML model in the list; and transmitting the combined ML model to the user devices for use or further training.

An alternative recipe is referred to herein as a “genetic algorithm”. FIG. 8B is a schematic diagram illustrating the genetic algorithm. The “greedy with discrete weights” recipe above assumes that the server will automatically obtain a new global model that outperforms the current best performing model if the starting point is this current best performing model. However, this assumption might not be always true and thus, this alternative recipe proposes exploring many other combinations (avoiding brute force). Consider a set of models {a, . . . , x, prev_best} described in a binary vector of the same length initialized with random values [1, . . . , 0, 1]. The starting point is a population of vectors that will evolve to obtain the best possible configuration. Vectors are evaluated (a “1” represents averaging a model), selected (delete Nd worst evaluations), combined (combine Nc best models by adding or multiplying these) and mutated (fill population with modified versions of the current best combination. Each vector position has a probability P of being mutated). The cycle is repeated for Ng generation and after this, the model that performed the best is selected. The selected model will be distributed to the user devices for use/inference or further training.

Thus, combining the received locally-trained ML models may comprise weighting the contribution of each locally-trained ML model to the new global ML model, by: defining a population of binary vectors, each binary vector corresponding to one of the received locally-trained ML models, wherein each binary vector is initialised with random values; evaluating each binary vector using an evaluation task to determine an evaluation score; selecting at least two binary vectors based on the evaluation scores; and combining the selected at least two binary vectors to generate at least one combined binary vector.

The method may further comprise: deleting any non-selected binary vectors from the population; mutating the combined binary vector to generate at least one mutated binary vector; and filling at least one space in the population that arises from the deleting with the at least one mutated binary vector.

The method may further comprise: repeating the steps of evaluating, selecting and combining for the at least one mutated binary vector; and transmitting a combined ML model corresponding to the combined binary vector which performs best at the evaluation task to the user devices for use or further training.

A further alternative recipe is referred to herein as a “weighted genetic algorithm”. This is essentially an extension to the “genetic algorithm” above, where the vectors contain float values that describe the weight of each of the models averaged instead of a {0.5,0.5} averaging.

### Model Implementation

The present techniques were evaluated on two standard benchmarks, DAVIS and YouTube. In all cases, the student was trained with an additional linear embedding layer and with an initially pre-trained space time correspondence network STCN as the teacher. Testing was performed on both a server grade GPU and a desktop grade GPU, whereby the present models are consistently at least twice as fast as competing methods for both long and short videos, while being up to 30× smaller. The smallest distilled model was then deployed on a mobile phone for real-time segmentation, which opens up the possibility for many new on-device applications.

The DAVIS datasets are high quality and high resolution densely annotated videos for video object segmentation. DAVIS'16 provides single object segmentation, with a validation set of 20 videos, while DAVIS'17 considers multi-object segmentation with both a validation and test set of 30 videos. YouTube-VOS 2019 is a large-scale benchmark dataset for multi-object segmentation. It consists of 3,471 videos for training and 507 videos for validation, across 65 categories. There are also 26 additional unseen categories in the validation set.

All of the experiments were conducted using 4 NVIDIA A10 GPUs with a batch size of 8. For evaluating the FPS metrics on the DAVIS datasets, a single NVIDIA A10 GPU with a batch-size of 1 was used. Adam was used as the optimizer, with a learning rate of 1e−5 and a weight decay of 1e−7. The training details and architectures are primarily unchanged from that in the original STCN, but are discussed in detail in the following sections.

Motivated by the goal to deploy these models on mobile devices, a few architectural modifications were made to the original STCN architecture. The value encoder is replaced with a MobileNetV2 backbone, while the query encoder is either replaced with ResNet18 or another MobileNetV2. The frame is also removed as an input to the value encoder and an ASPP module is used before the decoder, unless otherwise specified, to introduce more global context. ASPP is commonly employed in the SVOS literature.

The same training methodology followed by Cheng et al was used (Ho Kei Cheng, Yu-Wing Tai, and Chi-Keung Tang, Rethinking space-time networks with improved memory coverage for efficient video object segmentation. NeurIPS) except with two distinct modifications. Firstly, the sequence length of videos is extended to 5 to enable the student to learn features that are consistent across multiple frame predictions and secondly the poly cross entropy loss is taken as ϵ=1. In this way the model is encouraged to focus on the hard misclassified pixels.

The model is first trained on static images with synthetic deformations. The main training stage uses both the YouTube-VOS and DAVIS 2017 datasets for 600 k iterations and with a batch size of 8. BatchNorm layers are also frozen throughout all training stages.

Similar to RDE-VOS, the present techniques utilise Constant Cost (CC) to denote methods with finite memory during inference. Two different key encoder backbones are considered: a ResNet18 and a MobileNetV2. For the MobileNetV2 model results are shown with and without ASPP. Since the ResNet architectures achieve close to the original STCN performance, a purely contrastive loss i.e. ω=0.0 is chosen for ease of demonstration. This helps avoid overfitting to the teachers predictions on known classes and improve its generalisation to the unknown classes in YouTube. In contrast, for the much smaller MobileNet architectures, ω=0.95 is used. These much smaller models are unlikely to overfit, and thus can benefit more from the distillation objective. Thus can be seen how the choice of ω can be adapted to suit given circumstances and intended deployment. It is worth noting that, in all cases, the models are also jointly trained with logit distillation, where τ=0.1.

The present techniques (also referred to as MobileVOS below) is compared against previous state of-the-art methods on the DAVIS'16 and DAVIS'17 validation splits.

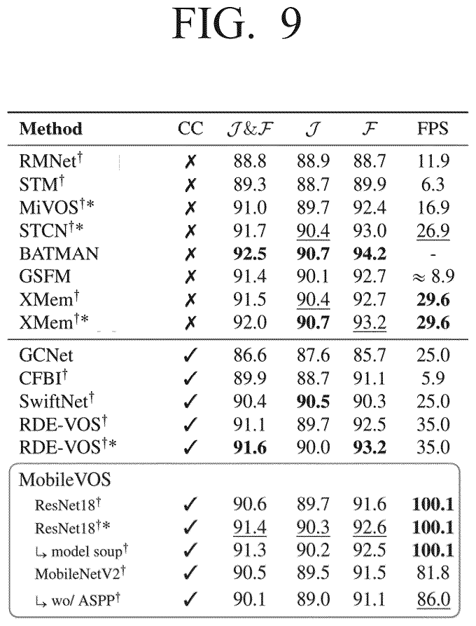

FIG. 9 shows a table of results on DAVIS'17. CC denotes constant cost during the inference. † indicates YouTube-VOS is added during the training stage. * denotes BL30K is added during the training stage. For both CC and non-CC methods, the best results are highlighted in bold, while the second best results are underlined. It can be seen that the present techniques are highly competitive, being only slightly (0.3 J &F) worse than the original teacher model STCN, but being nearly five and four times faster than STCN and RDE-VOS. Evidently the runtime performance is still competitive despite tracking multiple objects.

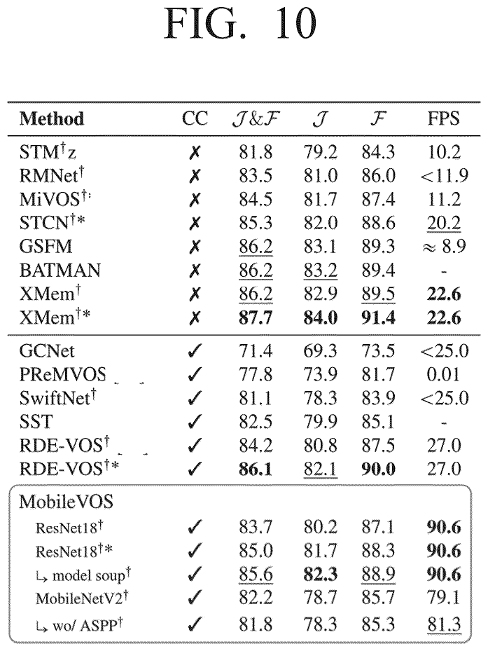

The results for DAVIS'16 are shown in FIG. 10, in which our best performing model is just 0.3 J &F shy of STCN and 0.3 J &F shy of RDE-VOS, while running four and three times faster than these models, respectively.

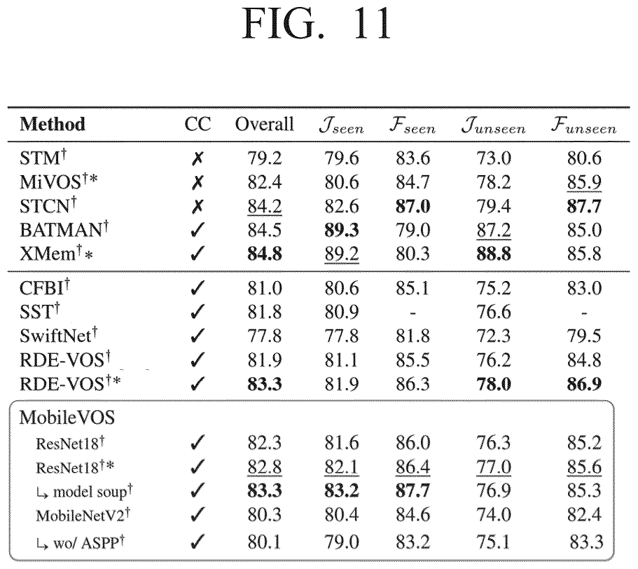

FIG. 11 shows a comparison of the present techniques against other state-of-the-art methods on the large-scale YouTube-VOS 2019 validation set. The present method outperforms RDE-VOS in the case where no BL30K pretraining is used, and is competitive in the case where it is used. Unlike RDE-VOS we report predictions from the same set of weights as in the DAVIS evaluation, and we observe only a 1.9 J &F drop with respect to the STCN teacher model.

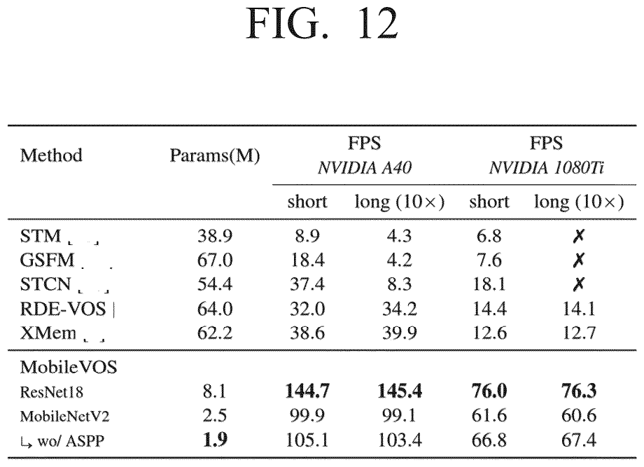

To conduct a fair comparison of the computational cost of previous works, Mobile VOS and other methods are jointly evaluated on the same set of hardware; in one example a server grade NVIDIA A40, and in another example a desktop grade NVIDIA 1080Ti. In all cases the models are input with a randomly generated video sequence of two different durations. The results can be seen in FIG. 12. Here the FPS was evaluated on a randomly generated video sequence with shape 480×910 and duration 50 (short)→200 (long).

The table in FIG. 12 shows that the present technique is significantly faster than others, and also significantly smaller. Note that the present method does not suffer from decreasing FPS in longer videos, as we have a constant cost memory. The largest model with ResNet18 has more than three times the FPS than RDE-VOS and ×8 fewer parameters, with highly competitive accuracy.

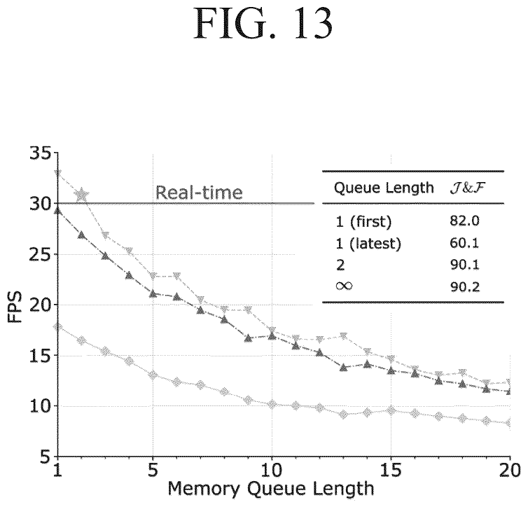

For the purpose of mobile deployment, latency of the present techniques were evaluated the on the GPU of a Samsung Galaxy S22 device. The models are first converted to tflite format and then benchmarked using the official tflite bench marking tool. To validate a choice of fixed memory size with 2 entries, FIG. 13 shows model latency against queue sizes between 1 and 20. The line with down markers is the MobileNetV2 wo/ASPP, up markers is the MobileNetV2, while diamond markers are for the Resnet18. The table shows J &F on the DAVIS 2016 validation set for MobileNetV2 wo/ASPP on memory queue lengths of 1, 2 and unbounded. The candidate that achieves the highest J &F, while maintaining real-time performance is shown with the star sign. The latency results are averaged across 100 runs.

FIG. 13 also shows a comparison of the J &F performance on the DAVIS 2016 validation set at different memory queue lengths, where there is a minimal accuracy degradation by reducing this length to 2. These two points motivate the choice of a memory queue length of 2.

The benefits of the present approach, in particular the proposed distillation loss, and its extensions, may be better understood via ablation studies.

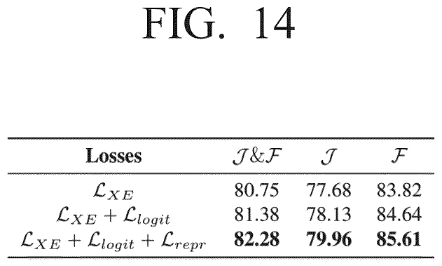

For the loss terms, the model is trained with the two distillation losses Llogit and Lrepr being incrementally added to the primary loss term (i.e. cross-entropy). The results presented in FIG. 14 show that both Llogit and Lrepr introduce improvements, especially the newly formulated Lrepr (note that in the table J & F matrices are averaged over both seen and unseen classes).

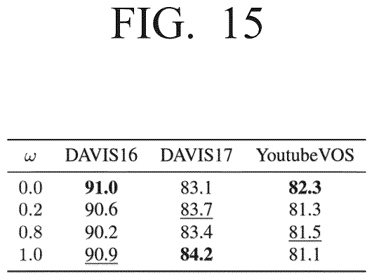

Sweeping over various ω values in Equation 7 to interpolate between supervised contrastive loss and representation distillation loss yields the results shown in FIG. 15 (for a ResNet18-backbone Mobile VOS).

The results indicate that the best results are achieved on DAVIS 2016 and 2017 with ω=1, where the loss is reduced to the distillation loss. We see the opposite trend on YouTube; the best results are with ω=0 that reduces the loss to the supervised contrastive loss. Current understanding is that in ω=0 case, it might not be possible to distil the unseen class knowledge from the teacher, whereas in ω=1 scenario, contrastive loss might lead to an improved class agnosticity, due to lowered dependence on object semantics.

To demonstrate the performance improvement attributed to sampling boundary pixels, there was performed an ablation experiment with a random sampling strategy. More specifically, logit distillation was used on all the pixels, and representation distillation on randomly selected pixels. Note that selecting all the pixels for representation distillation is prohibitively expensive due to the construction of the correlation matrices. It has been found that sampling the boundary pixels yields an improved convergence rate. Furthermore, this faster convergence leads to better J &F.

### Inference

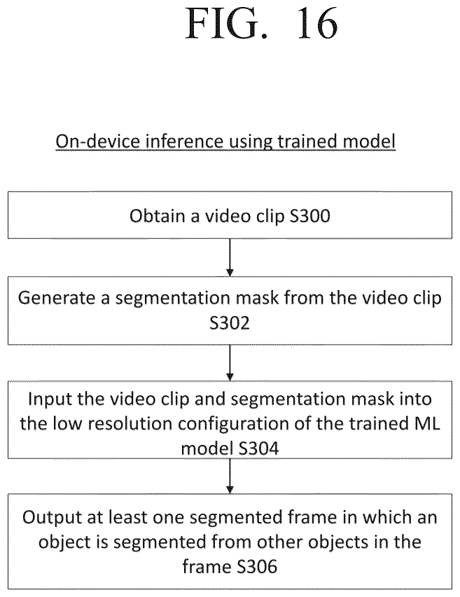

FIG. 16 is a flowchart of example steps for using a trained machine learning, ML, model to perform video object segmentation and track one or more objects in a video, the method comprising: obtaining a video clip comprising a plurality of frames and an object to be tracked through the frames; generating a segmentation mask for the object to be tracked based on a frame depicting the object; inputting the video and initial mask into a low resolution configuration of the trained ML model that has been trained according to any of the methods described herein; and outputting, from the low resolution configuration of the trained ML model, at least one segmented frame in which the object is segmented from the other objects in the frame. Advantageously, the low resolution configuration is used during inference, as this is much more suitable for execution on a resource-constrained device.

The method may further comprise: generating augmented frames from the segmented frames.

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from any inventive concept as defined in the appended claims.

What is claimed is:

1. A computer-implemented method for locally-training, on a user device, a machine learning, ML, model to perform video object segmentation and track one or more objects in a video, the method comprising:
obtaining a local training dataset comprising a plurality of video clips, each video clip comprising a plurality of frames;
generating a plurality of segmentation masks, each segmentation mask corresponding to a frame of a video clip of the plurality of video clips and relating to at least one object in the frame of the video clip;
obtaining a pre-trained global ML model comprising a high-resolution configuration and a low-resolution configuration; and
training the pre-trained global ML model to generate a locally-trained ML model using the local training dataset and the plurality of segmentation masks by:
processing, using the high-resolution configuration of the global ML model, a video clip from the plurality of video clips using a segmentation mask corresponding to a frame of the video clip, and generating a first set of segmented frames based on each frame of the video clip in which the at least one object of the segmentation mask appears;
generating a low-resolution version of the video clip;
processing, using the low-resolution configuration of the global ML model, the low-resolution version of the video clip and the segmentation mask corresponding to the video clip, and generating a second set of segmented frames based on each frame of the low-resolution version of the video clip in which the at least one object of the segmentation mask appears;
upscaling the second set of segmented frames;
comparing the first set of segmented frames and the upscaled second set of segmented frames; and
using a knowledge distillation loss to transfer knowledge from the high-resolution configuration to the low-resolution configuration to reduce a difference between the first set of segmented frames and the upscaled second set of segmented frames.

2. The method of claim 1, wherein using a knowledge distillation loss comprises using any one or more of: a cross-entropy loss, a cross-resolution loss, a boundary-aware logit loss, a representation loss, a contrastive learning loss, and an L2 distance loss.

3. The method of claim 2, wherein obtaining a local training dataset comprising a plurality of video clips comprises:
obtaining a set of videos from storage of the user device;
extracting at least one video clip from each video in the set of videos, where each video clip depicts a single scene from a single camera perspective and satisfies a segmentation mask generation requirement.

4. The method of claim 3, wherein extracting the at least one video clip from each video comprises using a shot detector machine learning, ML, model.

5. The method of claim 4, wherein generating a plurality of segmentation masks comprises generating at least one segmentation mask from each video clip using an initial frame in the video clip.

6. The method of claim 4, wherein generating a plurality of segmentation masks comprises generating at least one segmentation mask from each video clip using a non-initial frame in the video clip.

7. The method of claim 6, wherein generating at least one mask comprises using any one or more of: user interaction, super-pixel grouping, instance segmentation, and a saliency detection.

8. The method of claim 1, wherein obtaining a pre-trained global ML model comprising a high-resolution configuration and a low-resolution configuration comprising obtaining a pre-trained global ML model from a server.

9. The method of claim 8, further comprising transmitting the locally-trained ML model to the server for aggregation.

10. A user device for locally-training a machine learning, ML, model to perform video object segmentation and track one or more objects in a video, the user device comprising:
storage storing a local training dataset comprising a plurality of video clips, each video clip comprising a plurality of frames; and
at least one processor coupled to memory, arranged for:
generating a plurality of segmentation masks, each segmentation mask corresponding to a frame of a video clip of the plurality of video clips and relating to at least one object in the frame of the video clip;
obtaining a pre-trained global ML model comprising a high-resolution configuration and a low-resolution configuration; and
training the pre-trained global ML model to generate a locally-trained ML model using the training dataset and the plurality of segmentation masks by:
processing, using the high-resolution configuration of the global ML model, a video clip from the plurality of video clips using a segmentation mask corresponding to a frame of the video clip, and generating a first set of segmented frames based on each frame of the video clip in which the at least one object of the segmentation mask appears;
generating a low-resolution version of the video clip;
processing, using the low-resolution configuration of the global ML model, the low-resolution version of the video clip and the segmentation mask corresponding to the video clip, and generating a second set of segmented frames based on each frame of the low-resolution version of the video clip in which the at least one object of the segmentation mask appears;
upscaling the second set of segmented frames;
comparing the first set of segmented frames and the upscaled second set of segmented frames; and
using a knowledge distillation loss to transfer knowledge from the high-resolution configuration to the low-resolution configuration to reduce a difference between the first set of segmented frames and the upscaled second set of segmented frames.

11. A server for training a global machine learning, ML, model to perform video object segmentation and track one or more objects in a video, the server comprising:
at least one processor coupled to memory, arranged for:
transmitting, to a plurality of user devices, a pre-trained global ML model comprising a high-resolution configuration and a low-resolution configuration;
transmitting a request to the user devices to each train the pre-trained global ML model using local training datasets of each user device;
receiving, from some or all of the plurality of user devices, the locally-trained ML models for aggregation, the locally-trained ML models comprising locally-trained high-resolution and low-resolution configurations; and
combining the received high-resolution configurations of the locally-trained ML models and combining the low-resolution configurations of the locally-trained ML models to generate a new global ML model which outperforms the previous pre-trained global ML model.
